(19) United States
(12) Patent Application Publication
(10) Pub. No.: US 2003/0013414 A1
(43) Pub. Date: Jan. 16, 2003

(54) Radio system for providing wireless connectivity between digital devices

(76) Inventors: Yishao Max Huang, San Jose, CA (US); Sterling D. Du, Palo Alto, CA (US)

Correspondence Address: GLENN PATENT GROUP, 3475 EDISON WAY, SUITE L, MENLO PARK, CA, 94025, US

(21) Appl. No.: 09/905,207

(22) Filed: Jul. 13, 2001

(51) Int. Cl. H04B 1/38

(52) U.S. Cl. 455/41; 455/557; 455/556

(57) ABSTRACT

A wireless radio system for providing short-range wireless links between digital devices includes an RF transceiver and a digital baseband portion for establishing and maintaining links. The RF transceiver is embodied on a PC expansion card received b y a PC card expansion slot. At least a portion of the digital baseband is integrated on a host controller, equipped with logic sets for detecting and operating various types of expansion cards. One such logic set detects and operates the transceiver expansion card, so that a connection between the transceiver and the baseband is maintained. Removing the transceiver card detaches the transceiver, altogether eliminating wireless functionality. By substituting cards having transceivers adapted to local conditions, the radio system may be modified to accommodate regional variations in the LSM radio band.

### TECHNICAL FIELD

The invention relates to wireless communications. More particularly, the invention relates to a radio system for providing wireless connectivity between digital devices.

### TECHNICAL BACKGROUND

As mobile digital devices continue to proliferate, the need becomes more and more evident for a means for these devices to be able link wirelessly over short and medium-range distances. To that end, various standards have been proposed that allow such devices to form networks of various types: wireless LAN's, ad hoc networks, PAN's (Personal Area Networks); all by means of short and medium range wireless links mediated through RF transceivers. Among these new wireless technologies, the Bluetooth Standard and the IEEE wireless LAN standard (IEEE 802.11) are especially noteworthy.

Bluetooth

Bluetooth is a global standard for short-range wireless links between digital devices such as personal computers, cell phones and PDA's (personal digital assistants). Facilitating both data and voice communication, the Bluetooth wireless technology has been developed as a means of eliminating wires and cables between both stationary and mobile devices, and offers the possibility of creating personal area networks (PAN's) and ad hoc networks between multiple users of Bluetooth enabled devices.

The Bluetooth standard includes hardware, software and interoperability requirements. It is envisioned that Bluetooth will be adopted by most major equipment providers in the telecommunications, computer and home entertainment industries, and also in areas such as the automotive and health care industries and many other sectors of the economy.

Underlying Bluetooth is the fundamental idea of providing a low-power, low-cost radio interface between digital devices. For example, a small radio built into both a cell phone and a laptop computer could replace the cumbersome cable currently used to connect the two devices. In addition, Bluetooth offers the possibility of becoming a universal bridge to existing networks, a peripheral interface, and a mechanism to form small private and ad hoc groupings of connected devices away from fixed network infrastructures.

A Bluetooth SIG (Special interest group) formed in 1998 to monitor technical developments and to create an open, global standard, thus preventing the technology from becoming the property of a single company. This work resulted in the release of the first Bluetooth specification in 1999. One of the main goals was to include a regulatory framework in the specification to guarantee full interoperability between different devices from various manufacturers—as long as they share the same profile.

Hardware Architecture

The Bluetooth hardware consists of an analog radio portion and a digital baseband. The digital baseband includes a hardware digital signal processing part called the rink controller (LC), a CPU core and an interface to the host environment

The link controller includes hardware that performs baseband processing and physical layer protocols such as the ARQ protocol and FEC coding. The functions of the link controller include asynchronous transfers, synchronous transfers, audio coding and encryption.

The CPU core allows the Bluetooth module to handle inquiries and filter page requests without involving the host device. The link manager (LM), a layer that runs on the CPU core, discovers other LM's and communicates with them via the Link Manager Protocol (LMP) to perform its service provider role and to use the services of the underlying Link Controller.

In order to make different hardware implementations compatible, Bluetooth devices use the Host controller Interface as a common interface between the Bluetooth host and the Bluetooth core.

Radio frequency operation is in the unlicensed industrial, scientific and medical (ISM) band at 2.4 to 2.48 GHz using a spread spectrum, frequency-hopping, full-duplex signal at up to 1600 hops/sec. The signal hops among 79 frequencies at 1 MHz intervals to give a high degree of interference immunity. RF output is specified as 0 dBm (1 mW in the 10 m range and −30 to +20 dBm (100 mW in the longer range version.

Usage Models and Profiles

Various usage models have been developed for Bluetooth. For example, the Internet bridge allows Internet access by telephone or by computer, without any cable connections, regardless of location. When close to a wire-bound connection point, a mobile computer or handheld device can also connect directly to the landline, but without cables. The Ultimate Headset usage model allows hands free use of a cell phone, even if the phone is in the brief case. Automatic synchronization of calendars, and address books is possible. Simply by entering office, a Personal Area Network is established between all of a user's Bluetooth enabled devices; thus, the calendar in a user's phone or PDA is automatically updated to agree with the one on a desktop PC, allowing phone numbers and addresses to be correct and up-to-date on all digital devices without relying on cables or line-of-sight IR connections.

While usage models describe applications and intended devices, the profiles specify how to use the Bluetooth protocol stack for an interoperable solution. In each profile, it is stated how to reduce options and set parameters in the base standard and how to use procedures from several base standards. A common user experience is also defined. For example, a computer mouse doesn't need to communicate with a headset, and so they are built with different profiles. The profiles are a part of the Bluetooth specification and all devices must be tested against one more of the profiles in order to fulfill the Bluetooth certification requirements. The number of profiles will grow as new Bluetooth applications arise.

Compliance

The goal of the Bluetooth Qualification Program is to guarantee global interoperability between devices regardless of vendor and regardless of the country in which they are used. During the test procedure required of all devices, it must be verified that they meet all requirements regarding: radio link quality, lower layer protocols, profiles, and information to end-users.

IEEE 802.11

Similar in scope and purpose to the Bluetooth Standard is the IEEE Wireless LAN Standard (802.11). The hardware component, substantially identical to the Bluetooth hardware includes a digital baseband portion, an RF transceiver, and an antenna, all provided on a NIC (network interface card). Designed to operate in the ISM band, as Bluetooth does, IEEE 802.11 has higher power requirements, operates over greater distances and generally provides higher data transmission rates.

While a goal of both the Bluetooth Standard and the Wireless LAN Standard is to provide a global standard for operation in the unlicensed industrial, scientific and medical (ISM) band, in actual practice, the ISM band includes somewhat different frequency ranges from country to country. For example, Japan has expanded their ISM band, while certain European countries have a narrower range in their ISM band. What's more, in some countries, portions of the ISM band are utilized by the military. The differences in the ISM band from country to country create hardware incompatibilities that have limited the usefulness of Bluetooth- and Wireless LAN- enabled devices, forcing them to be region-specific, in spite of the original vision of a global standard. This region-specificity is a particular problem in the case of devices such as laptop computers in which the Bluetooth chipset has been embedded. The value to the user of such devices is seriously impaired when their full range of capabilities is only available in a limited geographic range. It would be a great advantage to provide a way of expanding the range of Bluetooth enabled digital devices so that they are fully functional anywhere in the world, unhampered by regional variations in the ISM band.

Providing the Bluetooth hardware as an embedded chipset poses an additional problem for users of mobile digital devices. Currently, in many countries of the world, notably the United States, wireless communications devices may not be used during airplane flights. In fact, passengers are required to turn off devices such as mobile phones and pagers prior to takeoff, and to leave them switched off for the duration of the flight. Under these regulations, the use of Bluetooth-enabled digital devices in flight is also prohibited. Thus, a passenger traveling with a laptop having an embedded Bluetooth chipset would be prevented from using their laptop computer during the flight. Being unable to use their devices for the duration of a flight possibly lasting twelve hours or more would seriously handicap many business travelers. Wireless LAN NIC's suffer this same disadvantage. Accordingly, it would be desirable to provide a simple way of disabling the wireless hardware without turning off the host device, thus enabling users of mobile computing devices to use them in environments where wireless devices are prohibited, such as in-flight.

Various types of removable or replaceable Bluetooth modules have been proposed. For example, a Bluetooth module that attaches to the universal serial bus by means of a dongle is known. Furthermore, a Bluetooth module embedded on a PC expansion card that attaches to a mobile computer by means of a Cardbus socket is also known.

Such cards are available from several hardware manufacturers. As FIG. 1 shows, the Bluetooth card 103 is inserted into an expansion slot 102A, 102B and connected with the host device through a controller 101. The card 103, has embedded thereon an RF unit 107 with an antenna 108, a digital baseband 106, a processor element 105, a ROM 109 and a proprietary interface 104. Due to their removable feature, these modules are easily disabled in environments where wireless devices are not permitted, simply by removing them. Conventional Wireless LAN NIC's are very similar to this Bluetooth expansion card. Fundamental to the Bluetooth standard is the principle that the Bluetooth hardware be very low in cost, thus encouraging its widespread adoption and enabling the technology to readily replace cables. The end user cost of a Bluetooth chipset is expected to be around ten dollars. The removable Bluetooth modules just described are considerably more expensive—in the case of a Bluetooth PC Card as shown in FIG. 1, the end user cost may approach several hundreds of dollars. The high end user cost of these modules renders them unsuitable for more than limited deployment; they are definitely incompatible with the basic design philosophy of the Bluetooth platform, that of a low-cost, widely available cable replacement solution. Therefore, it would be desirable to provide a Bluetooth implementation in which at least a portion of the Bluetooth hardware is readily replaceable, thus allowing the Bluetooth hardware to be quickly and easily detached. If the device were sufficiently low-cost, it would also be possible to provide the device in several different versions, each version suited to the regional variations of the LSM band.

Wireless LAN NIC's are available from a variety of manufacturers.

Hardware and software systems have been proposed in which an embedded Bluetooth chipset may be disabled and re-enabled through signals generated from the keyboard of the mobile computing device, either by means of a hot key, or a keystroke combination. However, such solutions are cumbersome for the user, and they would require re-engineering of the computer motherboard. Furthermore, they don't address the problem of hardware incompatibilities caused by region-specific variation in the LSM band.

There exists therefore a need in the art for a low-cost, user-friendly hardware implementation for Bluetooth and the Wireless LAN Standard that enables wireless links between digital devices anywhere in the world, independent of regional variations in the LSM frequency band. Furthermore, it would be advantageous to provide a simple way of disabling or disconnecting the wireless hardware, so that the host device could still b e used in settings where wireless devices are not permitted. It would be highly desirable to provide a solution that didn't require re-engineering of the motherboards of mobile computing devices such as notebook computers.

### SUMMARY OF THE INVENTION

A wireless radio system for providing wireless links between digital devices includes an RF transceiver and a multi-component digital baseband portion, connectable to the RF transceiver, that functions to establish and manage the wireless links. The RF transceiver is embodied on a PC expansion card of a type that is insertable into a Cardbus expansion slot and interfaced with a host device through a host controller. In one embodiment of the invention, the digital baseband portion of the radio system is integrated on the host controller. The host controller, equipped with logic sets for detecting and operating various types of expansion cards, operates to detect and operate the transceiver expansion card, so that a connection between the digital baseband and the RF transceiver is established and maintained. In alternative embodiments of the invention, selected components of the digital baseband are integrated on the host controller, while the remaining components are embedded on the PC expansion card with the RF transceiver. One embodiment of the invented radio system is designed to provide functionality compatible with the Bluetooth standard. A further embodiment provides compatibility with IEEE 802.11, the IEEE wireless LAN standard. Thus, the RF transceiver may be detached or replaced simply and inexpensively, altogether eliminating wireless functionality when desired, or allowing the system to be adapted to regional variations in the LSM band by swapping the transceiver.

In another aspect, the invention provides a method for detecting the presence of different types of PC expansion cards, including the card type of the previously described radio system that employs conventional PC card specification signal lines.

In yet another aspect, the invention provides a state machine for detecting the presence of a variety of expansion cards, including the card type of the above radio system, that includes a lookup table and multiple logic sets, in which each logic set is operative to interface with a predefined expansion card type.

### BRIEF DESCRIPTION OF THE DRAWINGS

FIG. 1 provides a block diagram of a conventional Bluetooth PC expansion card.

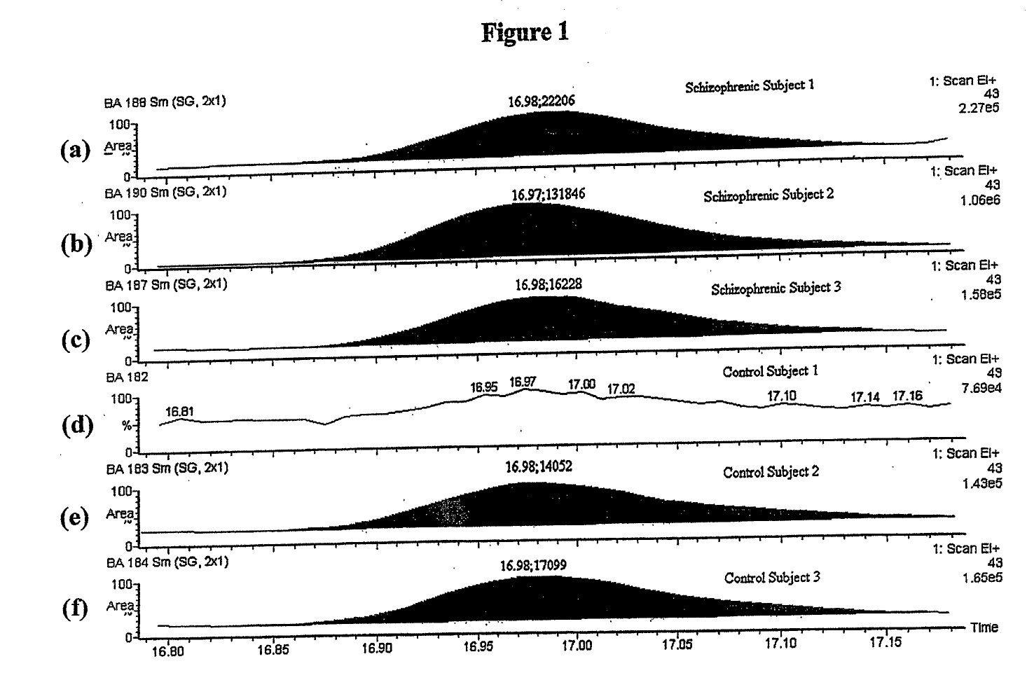

FIG. 2 provides a system level block diagram of a radio system for wirelessly linking digital devices, according to the invention;

FIG. 3 provides a detailed block diagram of the radio system of FIG. 2, according to the invention;

FIG. 4 provides a state machine block diagram of a host controller for detecting and operating a RF transceiver expansion card, according to the invention;

FIG. 5 shows a table of PC Card detection and voltage sensing pin arrangements, and an exemplary pin arrangement for detecting a RF transceiver expansion card by the controller of FIG. 4, according to the invention;

FIG. 6 is a flow chart of a scheme for detecting an RF transceiver expansion card, according to the invention; and

FIGS. 7A and 7B provide tables of connections for interfacing conventional PC cards and RF transceiver cards or NIC's according to the invention to a PC card socket, according to the invention.

### DETAILED DESCRIPTION

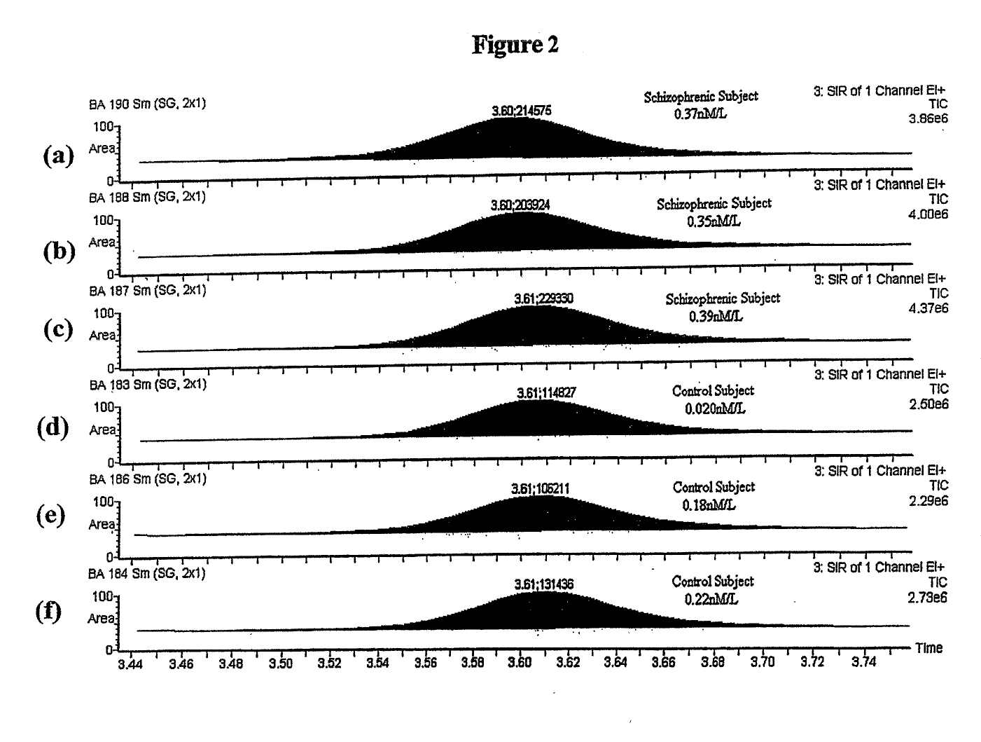

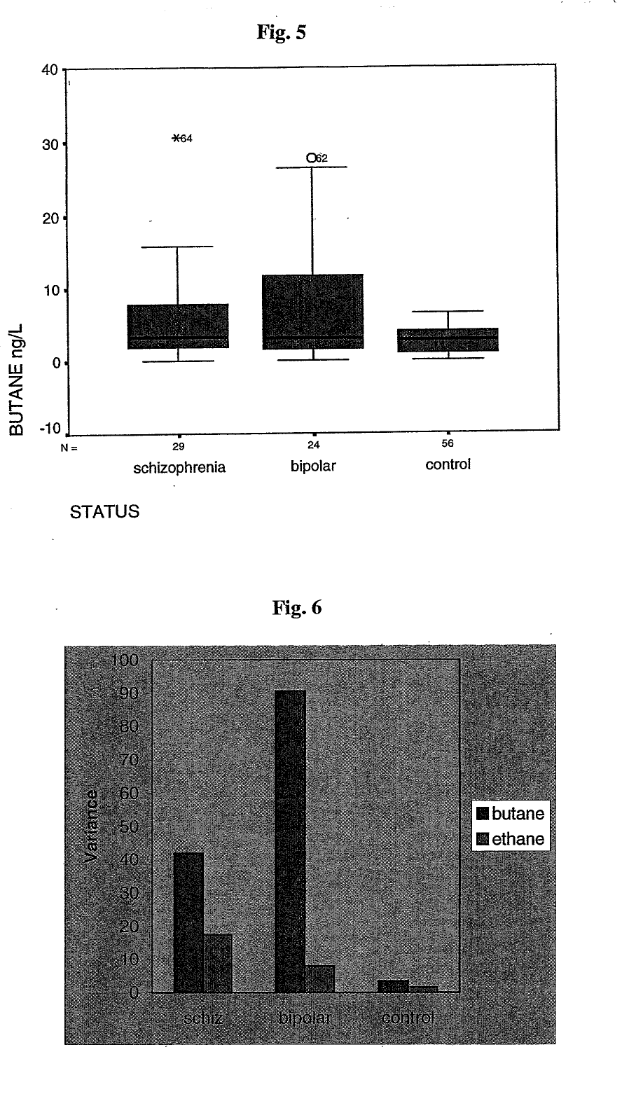

Referring now to FIG. 2, a system level block diagram of a radio system for providing wireless links between digital devices is shown. In a preferred embodiment, the invention is integrated into a mobile computing device such as a laptop computer. One embodiment of the invention is compatible with the Bluetooth Standard and provides, in a novel form, all of the hardware components specified by the Bluetooth standard. An alternate embodiment of the invention is compatible with the Wireless LAN Standard. Other embodiments of the invention are possible according to the distances, power requirements, type of devices to be linked, network protocol, and data transfer rate. As previously described, a wireless chipsets provide two basic hardware components: an analog RF transceiver, and a digital baseband portion. The invention provides the distinct advantages of being easily removable, thus allowing the radio system to be disabled or disconnected whenever the user may find it necessary. The invented radio system is readily adapted to region-specific variations in the LSM band by replacing the RF transceiver with one compatible with local conditions. Additionally, the current system can be provided at a greatly reduced end user cost over that of conventional removable modules. A host controller 10 functions to detect and control expansion cards inserted into either of both of the expansion slots A and B (12, 14). Advantageously, all or part of the digital baseband portion of the radio system is integrated on the host controller. The host controller 10 is, of course, also provided with the necessary logic to detect and operate conventional PC cards, both 16 and 32 bit. In one embodiment of the invention, the entire digital baseband is integrated onto the host controller. However, other embodiments of the invention are possible in which only selected components of the digital baseband are integrated on the host controller. Furthermore, an embodiment is also possible in which only one of the baseband components is integrated on the host controller. In either case above, the remaining baseband components are embodied on the RF transceiver expansion card. In general, the mobile system includes a processor 26 and a data bus 20. The data bus may be a PCI bus as shown in FIG. 2, however other bus technologies are compatible with the spirit and scope of the invention. Conventional north bridge logic 24 provides communication between the processor and the data bus. Conventional south bridge logic provides for external bus communications. A power IC chip 28 supplies the appropriate driving voltage (v_{CC}) to operate PC cards inserted into either of the expansion slots 12 or 14, according to the type of card inserted in the expansion slot. Card type is established by a PC card's connection to its card detection pins, as shown in FIG. 5. The manner in which the host controller 10 interrogates the socket to determine card type is described in greater detail below.

As FIG. 2 shows, the digital baseband, integrated on the host controller, and the RF transceiver are connected to each other by inserting the RF transceiver PC card 16 into either of the expansion slots 12 and 14. The card 16 has embodied thereon a RF transceiver 18 having functional capabilities compatible with either or both of the Bluetooth and the Wireless LAN standards. Additionally, an antenna 19 is connected to the transceiver 18. The current embodiment of the invention provides a PC card having only a transceiver and antenna embodied thereon, with all components of the baseband being integrated on the host controller 10. However, as previously indicated, only selected components of the baseband may be integrated on the controller, with the remaining components being embodied on the card 16. The radio system according to the invention is extremely cost-efficient. Integrating the baseband on the host controller, so that the PC card need only provide an RF unit allows the provision of a very low-cost, removable module. Furthermore, the card 16 is provided in a several different versions, each one having an RF unit 18 adapted to region-specific variations in the LSM band.

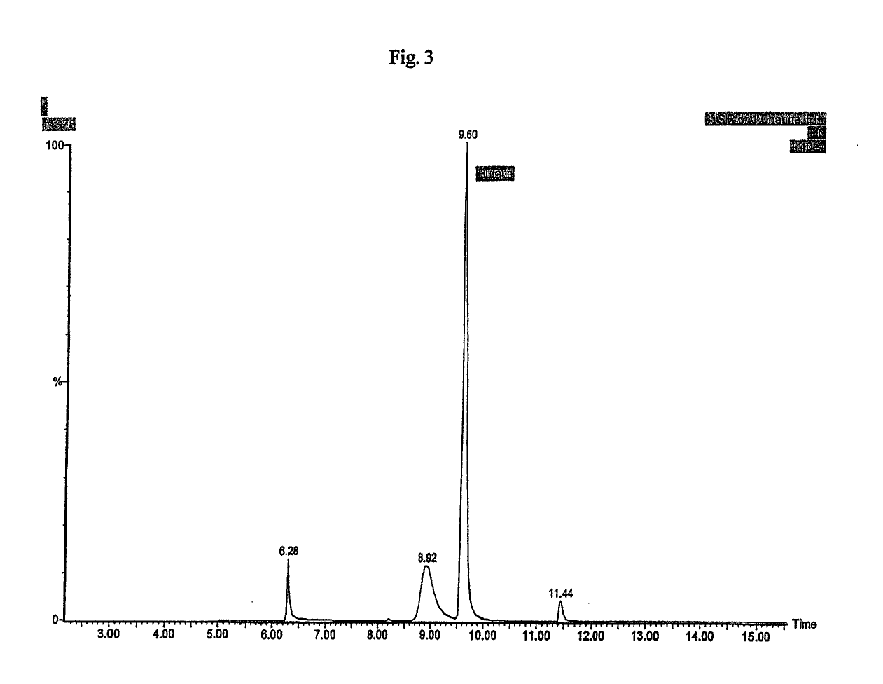

Turning now to FIG. 3, a more detailed block diagram of the invention is provided. Specifically, the integrated host controller 10 is shown, including logic portions for detecting and operating an RF transceiver expansion card 16, according to the invention.

As shown, sensing logic 30a and 30b for the transceiver card 16, multiplexer logic 32A and 32B, baseband hardware 34A and 34B and interface logic 36A and 36B are integrated onto the host controller 10.

As shown, the baseband hardware 34A and 34B includes:

a lower link controller (LLC) for byte level processing of the lower layers of either protocol;

a RF-to-DSP link for interfacing the transceiver IC 18 with the LLC

a baseband core, consisting of a RISC processor such as a ARM 7 CPU; and

a memory, such as a dual port SRAM for FIFO use.

Although not shown, one skilled in the art will recognize that the host controller also includes logic and hardware components for sensing and operating conventional 16-bit and 32-bit PC cards. Conventionally, PC card controllers detect card type by means of a pair of Card detection pins, CD1 and CD2, and voltage sense pins VS1 and VS2. During interrogation by the controller 10, the coupling combinations of these pins indicate which type of card has been inserted into the expansion socket. Interrogation is performed by driving VS1 and VS2 to V_{CC}, and monitoring the card detection pins for continuity between one of the voltage sense pins and one of the card detection pins. When driving each voltage sense pin to V_{CC}, if both card lines remain at ground, the controller recognizes that both card detection pins are tied to ground, and the card inserted is a 16-bit card. If either of the card detection pins are sampled at V_{CC}, indicating continuity between one of the voltage sense and card detection pins, the controller recognizes that a 32-bit card is inserted. As shown in FIG. 5, two columns are reserved in the Cardbus standard. The invention utilizes one of the reserved columns along with a status change interrupt, STSCHG, to detect whether a transceiver card 16 has been inserted into one of the expansion slots, 12 and 14. Conventionally, in the Cardbus specification, STSCHG interrupts are only used to signal:

Ready state changes;

Write-protect state changes; and

Battery voltage detect state changes, after a card has been detected.

When an RF transceiver card or NIC is inserted into an expansion socket, sensing logic 30A or 30B communicates with baseband hardware 34A or 34B to interface the radio IC with the baseband. In turn, multiplexer logic 32A or 32B is enabled, so that data received through the RF transceiver as an analog signal from another digital device may be processed and communicated to the PCI bus via PCI interface with controller logic 36A or 36B. Communication with the bus interface controllers occurs by means of conventional PC card communication protocols. One skilled in the art will recognize that conventional detection logic integrated on the controller 10 enables multiplexer logic 32A and 32B and communicates with the bus controllers 36A and 36B in the event that a conventional 16-bit or 32-bit card is inserted into the expansion slot. As previously described, either voice or data communication is enabled between digital devices. Thus, the baseband hardware 34A, 34B also communicates directly with an audio component 39, without the intermediation of the bus controller logic 36A, 36B.

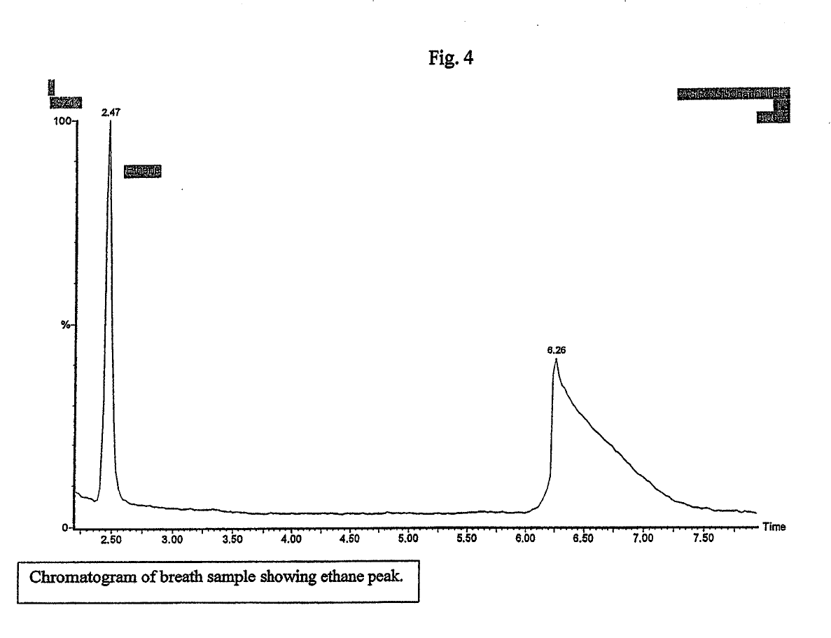

The sensing logic, in fact, constitutes a state machine that determines the type of card inserted into a socket, as shown in FIG. 4. The card sensing logic 30A or 30B accepts CD1, CD2, VS1, VS2 and STSCHG (40, 41, 42, 43, 44, respectively) as inputs. According to the pin coupling arrangements as provided in FIG. 5, along with a status change interrupt, the state machine 30A determines the appropriate logic 32A for operating the card inserted. As previously described, various combinations of CD1, CD2, VS1 and VS2 indicate the presence of a conventional 16-bit or 32-bit expansion card, whereupon logic 50 or 52 is activated. During sensing, the driving voltage, V_{CC}, of the card is also determined. Advantageously, the controller 10 also monitors the STSCHG pin to detect the presence of a RF transceiver card or NIC, thus activating logic 54 to operate the RF card. As previously described, the controller performs an interrogation to determine the states of the pins. Interrogation may occur by means of a pulse train signal applied to selected pins, and simultaneously monitoring the signal on one or more of the remaining pins.

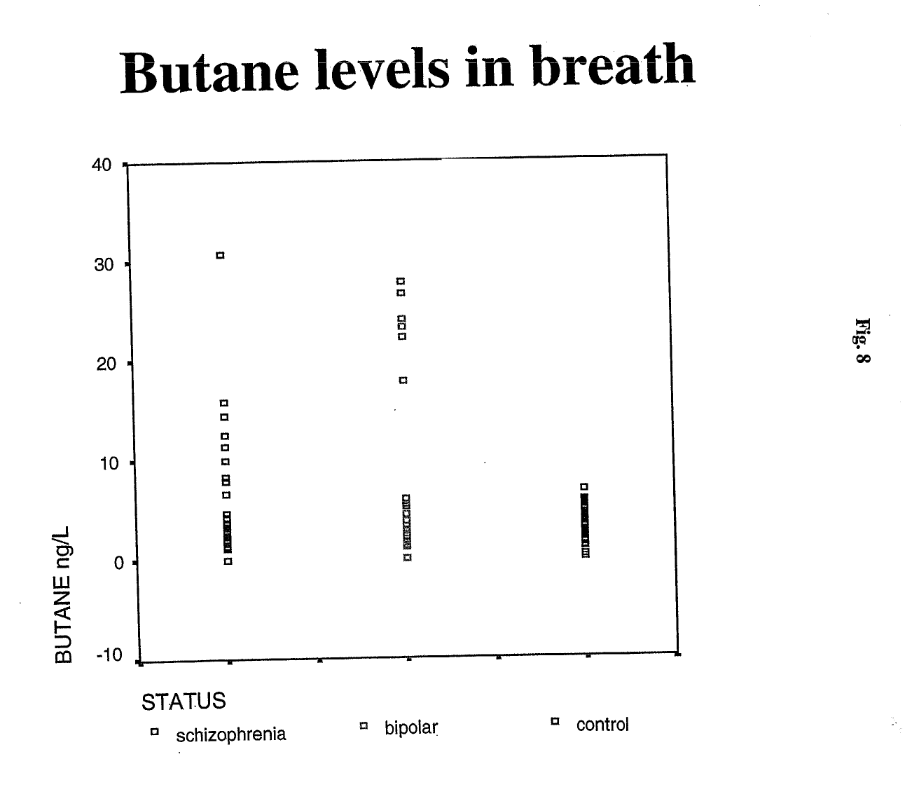

The sensing logic 30A, 30B is operative to detect either conventional cards or the RF transceiver card or NIC of the current invention, according to the pin coupling arrangements shown in FIG. 5, designated by the Cardbus specification and well known in the art. The card type is determined by measuring the values of the voltages of columns 1-4: CD2, CD1, VS2 and VS1. The RF transceiver card or NIC is detected through one of the reserved columns, plus the use of an additional pin, such as the STSCHG pin. The pin assignments for the detection signals are summarized in the table of FIG. 7B. The signal column for the RF transceiver card or N IC, also referred to as the BlueCard, includes either of the two reserved columns as shown in the last two rows of FIG. 5. While the Figures show the use of the STSCHG signal line, the invention could actually use any pin that remains unused during the period of conventional PC Card detection, CINT or CSERR, for example. The invention makes use of at least one of such signal lines in addition to one of the reserved pin columns in order to identify a RF transceiver card or NIC.

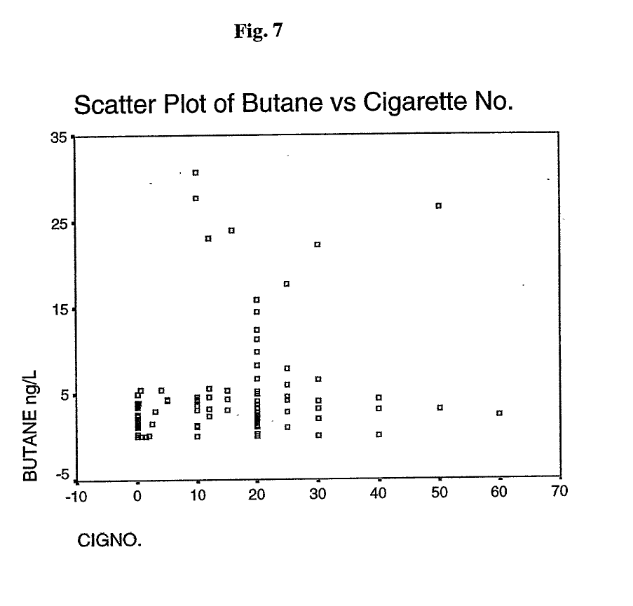

FIG. 6 shows a flow chart 60 of the card detection process. Initially, the detection logic seeks the presence of CD1, CD2, VS1, VS2 and STSCHG 62. If they are not detected, the logic assumes that no card has been inserted into the expansion socket, and the card detection signals CD1 and CD2 are blocked 64. After a card has actually been inserted, the detection logic monitors the falling edge of CD1 or CD2 66, as dictated by the Cardbus specification. When a card is detected, the invented detection logic toggles CD1, CD2, VS1, VS2 and STSCHG to determine the card type 68. As previously described, toggling may be by means of a pulse train signal or other toggling signal. After toggling, the detection logic proceeds to poll CD1, CD2, VS1, VS2 and STSCHG in the following manner:

Logic determines if VS1 and CD2 are tied to ground 70; “no” indicates that a conventional 16-bit or 32-bit PC card is inserted 72;

If “yes”, logic determines if VS2 and CD1 are tied together 74; “no” again indicates that a conventional 16-bit or 32-bit PC card is inserted 76;

If “yes”, logic determines if CD1 and STSCHG are tied together 78;

If “yes”, then a RF transceiver card or NIC according to the invention is present 80;

If “no”, then a reserved card of another type is present 82.

The invention also provides an integrated controller circuit 10 that can be integrated directly with current PC expansion card controller logic. Conventional PC expansion card controller logic is embodied as a 208 pin IC package mounted directly on the motherboard of a personal computer, such as a laptop. Each of the pins is assigned b y the Cardbus specification. Advantageously, the controller of the current invention can replace a conventional controller without the necessity of reconfiguring pin assignments, adding additional pin configurations, altering the motherboard, or changing the required tooling, rendering the invented controller completely compatible with the existing Cardbus standard while providing the additional functions previously described. As shown in the table of FIG. 7, the controller 10 includes both conventional legacy interface card signals and signals for the invented expansion card. As the table shows, the same pins used to interface with conventional 16-bit and 32-bit cards function to interface with the invented card. Accordingly, no additional pins are required. Thus, When an RF transceiver card or NIC is inserted into an expansion socket, sensing logic 30A or 30B communicates with baseband hardware 34A or 34B to interface the radio IC with the baseband. In turn, multiplexer logic 32A or 32B is enabled, so that data received through the RF transceiver as an analog signal from another digital device may be processed and communicated to the PCI bus via PCI interface with controller logic 36A or 36B. Communication with the bus interface controllers occurs by means of conventional PC card communication protocols. One skilled in the art will recognize that conventional detection logic integrated on the controller 10 enables multiplexer logic 32A and 32B and communicates with the bus controllers 36A and 36B in the event that a conventional 16-bit or 32-bit card is inserted into the expansion slot.

To ease integration with conventional PC Card logic sets, the invention controls a predetermined number of pre-assigned pins to enable RF transceiver card or NIC operation. As FIG. 7A shows, pins 17, 51, 58, 47, 32, GND 18, 16 and 40, as specified by the CardBus standard, are utilized by the invention to operate both RF transceiver card or NIC and conventional PC cards. Thus, no additional pins are required by the controller 10. In actual use, when a RF transceiver card or NIC has been detected, as previously described with reference to FIGS. 3-6, logic 34A or 34B reassigns the operability of the PC Card pins listed in FIG. 7A to operate the RF transceiver card or NIC.

The tables of FIGS. 5, 7A and 7B are included in the controller 10 as lookup tables. Thus, during card detection, the state machine of FIG. 4 compares input signals with the lookup tables provided by FIGS. 5 and 7B to couple the appropriate logic to the inserted card.

Although the invention has been described herein with reference to certain preferred embodiments, one skilled in the art will readily appreciate that other applications may b e substituted without departing from the spirit and scope of the present invention. Accordingly, the invention should only be limited by the claims included below.

What is claimed is:

1. A radio system for wirelessly linking digital devices, comprising:
an RF transceiver embodied on a PC expansion card;
a host controller for detecting and operating said RF transceiver expansion card, wherein said controller includes logic sets for detecting and operating a plurality of expansion card types; and
a digital baseband portion, connectable to said transceiver, for establishing and managing said wireless links, said baseband portion including a plurality of components, wherein at least one of said components is integrated on said host controller.

2. The radio system of claim 1, wherein said RF transceiver expansion card includes only said RF transceiver, and wherein all components of said digital baseband are integrated on said host controller.

3. The radio system of claim 1, wherein said transceiver expansion card includes base band components not integrated on said host controller.

4. The radio system of claim 1, wherein said transceiver expansion card further comprises an RF antenna.

5. The radio system of claim 1, wherein said components include one or more of:
a baseband core;
at least one memory;
signal processing means;
a lower link controller; and
at least one bus bridge.

6. The radio system of claim 5, wherein said signal processing means comprises an interface between said RF transceiver and said lower link controller.

7. The radio system of claim 1, wherein said controller comprises a host controller.

8. The radio system of claim 7, wherein said logic sets include:
a first logic set for detecting and operating 16-bit PC cards;
a second logic set for detecting and operating 32-bit PC cards; and
a third logic set for detecting and operating said RF transceiver expansion card.

9. The radio system of claim 1, wherein said transceiver expansion card is received in an expansion card slot on a digital device during use, so that said transceiver expansion card and said controller are electrically connected.

10. The radio system of claim 1, wherein said system, said transceiver and said baseband are Bluetooth compatible.

11. The radio system of claim 1, wherein said system, said transceiver and said baseband are compatible with a Wireless LAN Standard.

12. A method of detecting the presence of an expansion card using conventional PC card specification signal lines, said method comprising the steps of:
determining the signal state of first and second card detection signal lines;
determining the signal state of first and second voltage select signal lines;
determining if said first and/or second card detection signal lines, or said first and/or second voltage select signal lines, comprise a signal state that is reserved by a PC Card signal specification; and
determining the signal state of a predetermined unused PC Card signal line, relative to said reserved signal state.

13. The method of claim 12, further comprising the steps of:
determining the presence of a RF transceiver expansion card by determining whether said first card detection signal and said second voltage select signals are tied together.

14. The method of claim 12, wherein said steps of determining said signal lines comprise the steps of:
polling said signal lines with a predetermined input signal; and
measuring an output signal.

15. A device to detect the presence of an expansion card using conventional PC Card specification signal lines, said device comprising a state machine including a lookup table and a plurality of logic sets, each of said logic sets operable to interface with a certain predefined expansion card type, said state machine accepting as input signals a plurality of predetermined card detection and voltage selection signals, and an additional signal, and coupling an appropriate one of said logic sets to an appropriate one of said expansion card based on a match between said input signals and said lookup table.

16. The device of claim 15, wherein said logic sets include a first logic set to operate a 16-bit expansion card, a second logic set to operate a 32 bit expansion card and a third set to operate a RF transceiver expansion card or network interface card (NIC).

17 The device of claim 15, wherein said lookup table comprises a plurality of assigned signal state definitions for said input signals, said signal state definitions including interface type and operating voltage for a plurality of expansion card types.

18. The device of claim 15, wherein said additional signal comprises a signal that is not assigned for use during a card detection event by a PC Card specification.

19. The device of claim 18, wherein said additional signal is a status change (STSCHG) signal.

20. An integrated circuit for detecting and operating a plurality of expansion card types, comprising:
a first logic set for detecting and operating a plurality of expansion card types, said first logic set having predetermined signal lines and a pinout arrangement defined according to PC Card specifications, and a second logic set for detecting and operating a Bluetooth compatible radio unit embodied on a PC expansion card, or a Wireless LAN NIC, said first and second logic set being incorporated into a single controller, and wherein said second logic set is adapted to reassign certain ones of said predetermined signal lines to detect and operate said Bluetooth PC card or Wireless LAN NIC without requiring additional pinouts.
